(19) United States
(12) Patent Application Publication
(10) Pub. No.: US 2010/0114764 A1
(43) Pub. Date: May 6, 2010

(54) System and Method for Selectable Funding of Electronic Transactions

(76) Inventors: Glen R. Cataline, Dublin, OH (US); William Smith Rielly, Redmond, WA (US); William Scott Wallace, Downington, PA (US); Mark Robert Sheehan, Middleton, DE (US)

Correspondence Address: GOODWIN PROCTER LLP, 901 NEW YORK AVENUE, N.W., WASHINGTON, DC, 20001, US

(21) Appl. No.: 12/606,348

(22) Filed: Oct. 27, 2009

Related U.S. Application Data
(63) Continuation of application No. 09/985,900, filed on Nov. 6, 2001.
(60) Provisional application No. 60/245,555, filed on Nov. 6, 2000.

(51) Int. Cl. G06Q 40/00

(52) U.S. Cl. 705/40

(57) ABSTRACT

A system for transferring funds to pay bills and to and from selected accounts on an optimized is provided. A mediation engine may manage the payments made to selected payees, including by scheduling the payments and selecting sources for funds. A rules-based optimizer may automatically select the least-cost or other most efficient or desirable transaction, given the customer's available funds, types of funds and payment date. All payment providers and payees may manipulated using one seamless view. A customer service representative may also view the transfers.

### CROSS REFERENCE TO RELATED APPLICATIONS

The subject matter of this application is related to the subject matter of provisional application U.S. Ser. No. 60/245,665 filed Nov. 6, 2000, assigned or under obligation of assignment to the same entity as this application, from which application priority is claimed, and which application is incorporated by reference.

### FIELD OF THE INVENTION

The invention relates generally to electronic commerce, and more particularly to a system and method for selectively scheduling payment and other transactions such as bill pay from a variety of sources and according to selectable schedules, while optimizing those transactions for least cost and other benefits to the payment enabler, consumer or others.

### BACKGROUND OF THE INVENTION

Electronic commerce, such as personal banking via the Internet, has become increasingly popular. Many electronic banking applications enable a user to perform banking related transactions from home, such as through a personal computer, browser-equipped cellular phone, electronic wallet (both client side and server side) or other client device. Using the client device, a user may manipulate a graphical user interface to transfer funds between accounts, direct a wire payment to a third party, redeem securities or perform other transaction functions.

Electronic banking may however suffer from the drawback that it is difficult for a user to manipulate and move funds when and how the person desires. Some systems require a user to access multiple graphic user interface screens to effectuate the transfer of money, even from just one source account to just one recipient. These access requirements, possibly including repeated logins, may lengthen the process and cause user confusion, thereby discouraging a user from accessing the service.

Electronic banking may also suffer the drawback of defaulting to a payment mechanism which may not be the most efficient or cost effective manner for achieving various transactions. For example, some methods for transferring funds may be more expensive than others. A balance transfer transaction using a credit card account as a source of payment which is executed at a cost of, for example, 3% of balance may be more expensive than an ACH transfer, or transmitting a personal or certified check or postal or bank money order to satisfy the same credit card or other bill.

The host financial institution, acting as the payment enabler to the transaction, may therefore absorb different internal costs depending on the payment mechanism chosen by the user, or to which the transaction defaults. The consumer may in cases see those differing transaction costs reflected in different fees charged to them.

Moreover some financial institutions, from the point of view of internal operations, consider certain categories of funds transfer, including the Automated Clearing House (ACH) and wire transfer, as risky since authenticating the identity of the customer may be difficult or impossible. However security criteria may not always be factored into transaction defaults or rules. Other parameters, such as contractual obligations such as minimums with different payment providers, possible volume discounts, tiered rewards thresholds and others may not be taken into account in the ordinary routing of transactions.

The consumer, business or other payment initiator for their part may need to be aware of various payment mechanisms and the costs associated with each method of delivering payment to determine the most cost-effective way of transmitting funds, without assistance from the electronic payment system itself.

Fulfillment services may therefore be more expensive for providers and users than necessary, and less expedient or secure than they could be.

Further, many financial institutions such as banks, credit card companies, mortgage companies, securities houses and other entities contract with a single third party bill payment provider to have bills presented and paid on their behalf using bill pay platforms. Typically the Web site or telephone bill pay products are branded by the provider to represent the financial institution. In some cases the financial institution maintains the user interface but in other cases, the bill payment provider provides the user interface. Examples of bill payment providers include CheckFree, Spectrum, ePrinceton Telecom, M&I and others.

In addition, in most cases only one bill payment provider can be used at one time or by one customer due to a financial institution's inability to provide a consolidated view of the various bill payment and transfer methods. Usage of multiple bill payment services and transfers may cause further confusion for the customer, and the institution's customer care team.

An integrated, programmable and optimizing technique for managing various fund transfers and other transaction, and providing tracking to the customer and customer service representative, is not available. Other drawbacks exist.

### SUMMARY OF THE INVENTION

The invention overcoming these and other problems in the art relates in one regard to a system and method for selectable funding or adaptable routing of transactions, including electronic and other transactions, which enables a payment initiator such as a consumer, business or government entity to select, schedule, maintain and optimize the timing and technique used to effect various payments, including to schedule bill payments on time and at least cost to the payment enabler or payment initiator.

In one regard, the invention may permit a payment initiator to transparently enjoy the benefits of optimization, once payment schedules and other data are input, since the system arranges for the best available delivery mechanism to satisfy the scheduled payment obligations automatically. The invention may furthermore achieve economies for the bank or other participating institution, since payment sourcing and routing may be optimized at the level of the payment enabler, as well as for the consumer. The invention in another regard may increase the range and flexibility of available funding sources, as well as recipients, using an integrated mediation engine.

### BRIEF DESCRIPTION OF THE DRAWINGS

FIG. 1 is a schematic representation of a system for transferring funds according to an embodiment of the invention.

FIG. 2 is a flowchart illustrating funds processing according to an embodiment of the invention.

FIG. 3 illustrates a user interface to schedule and manage payment transactions according to an embodiment of the invention.

FIG. 4 illustrates optimization processing according to an embodiment of the invention.

### DETAILED DESCRIPTION OF PREFERRED EMBODIMENTS

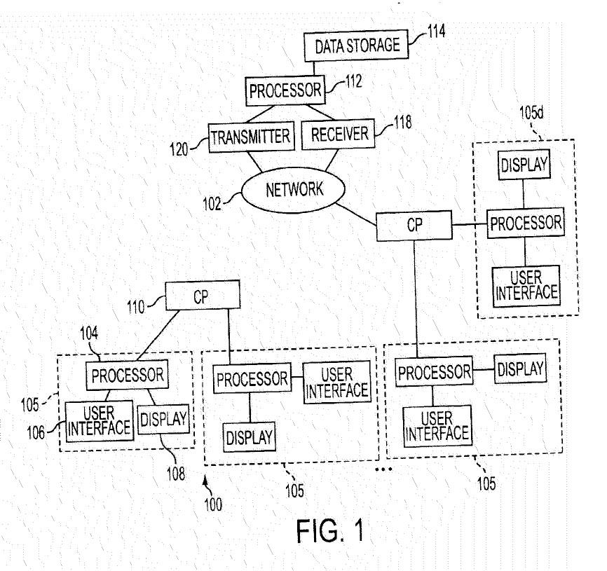

As illustrated in FIG. 1, the payment system 100 of the invention in one regard provide a consumer, business or other payment initiator with an integrated interface with which to manage the programmable payment of a number of types of bill and other payments from diverse sources of funds on an optimized basis.

For instance, using the payment system 100 of the invention the payment initiator may schedule electronic, paper or other payments to, for instance, a mortgage account, a car finance or lease account, credit card or merchant card accounts, utility accounts, contribution accounts such as 401(k) or educational or charitable accounts, or other accounts or recipients through an integrated and relatively streamlined interface. The invention in another regard may interface to conventional software packages, such as personal finance managers (PFMs) or others as a front end, to increase ease of use for consumers, businesses and other payment initiators familiar with those tools.

The payment initiator may schedule those funds transfers from a variety of source accounts, such as checking or other demand deposit accounts (DDAs), money market funds, securities accounts, stored value accounts, other credit card accounts, currency accounts, overdraft lines of credit, micro payment accounts, lines or credit or other accounts or facilities which may act as a source of funds.

The payment system 100 of the invention in an embodiment provides a flexible, one-view interface to all of the possible sources and recipients of one-time or recurring funds transfers. The payment initiator may therefore view and manage all their transactions without resorting to multiple platforms or performing multiple authentications.

In another regard, the payment system 100 of the invention may automatically drive transactions from source funds to recipient accounts using the most efficient transfer mechanism available for the payment the user has selected. For instance, a payment initiator may select to have a payment made on a credit card account by way of a check or other payment or instrument drawn on a deposit account by a certain day of the month while maintaining funds availability for the longest possible time.

The payment system 100 of the invention may then analyze the costs and delivery timeline for that fund transfer to effectuate the most optimal available transfer. Factors taken into account to optimize the transaction may include the identity of the payee as the funding destination (such as a credit card provider), the delivery timeline (such as the number of days until the payment must be made), the funding source (such as a financial institution providing a direct deposit account), and any third party providers having a relationship with the funding source, including identifying those that offer rewards or other benefits accrue through that channel.

Other optimization factors or rules may include costs to the payment initiator and to the bank or other host entity, contractual or other account minimums, the reliability of the payment channel, dollar amount (e.g. micropayments or macropayments), any discounts for quantity of transactions or amounts of transactions, and other rules-based intelligence. In an embodiment of the invention, the payment system 100 may also aggregate multiple payment transactions to increase efficiency, such as for instance aggregating all of one payment initiator's payments to a single large bank for a month, or the transactions of multiple customers to realize rewards leverage, economies of scale or other benefits.

Other factors accounted for in performing an optimized calculation include the type or category of payee, payment thresholds, tiered rewards or other graduated benefits, the type and nature of any intermediary account used to effect the transaction, and others. Two or more of a payment source, intermediary and a payee for instance may be identified as both belonging to the same association or network, permitting efficiencies to be realized when remaining within the association or network. The factors and rules taken into account may be modified over time to reflect changing market conditions, refinements to the transaction model and other evolving criteria.

As a result, the payment system 100 may determine that the funding destination, such as a revolving credit account provider, is a member of a third party association with which the funding source subscribes or otherwise has to access to, such as the commercially available Spectrum service. As a result, the cost of the scheduled payment may be reduced by routing the payment through the common association (such as Spectrum or others) with the payee, rather than routing the transaction through a default payment provider outside the association.

By contrast, the payment system 100 may determine that the payee account and the funding source, or the host entity itself, are part of the same organization. In this instance, an internal transfer may be determined to be the most cost efficient mechanism for effecting payment, without resort to any external payment network. Costs may be reduced for both payment initiator and payment enabler, in that scenario.

In operation, as illustrated in FIG. 1, consumers, businesses, government entities and other payment initiators may use one or more clients 105 to access the payment system 100 through network 102, for instance through multiple connector providers (CPs) 110 such as Internet service providers (ISPs) or others.

According to an embodiment of the invention, the clients 105 may be or include, for instance, a personal computer running Microsoft Windows™ 9x, Millenium™, NT™, 2000 or XP™ Windows™CE™, MacOS™, PalmOS™, Unix, Linux, Solaris™, OS/2™. Clients 105 may also be or include a network-enabled appliance such as a WebTV™ unit, radio-enabled Palm™ Pilot or similar unit, a set-top box, a networkable game-playing console such as Sony Playstation™, Sega Dreamcast™ or Microsoft XBox™, a browser-equipped or other network-enabled cellular telephone, an automated teller machine (ATM), an electronic wallet (client side or server side), or other TCP/IP client or other device, or a stand-alone Website offering. Client 105 may yet further be, include or interface to character recognition platforms or voice recognition platforms or other channels.

Network 102 may be, include or interface to any one or more of, for instance, the Internet, an intranet, a LAN (Local Area Network), a WAN (Wide Area Network) a digital T1, T3, E1 or E3 line, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or other connection. Network 102 may furthermore be, include or interface to any one or more of a WAP (Wireless Application Protocol) link, a GPRS (General Packet Radio Service) link, a GSM (Global System for Mobile Communication) link, a CDMA (Code Division Multiple Access) or TDMA (Time Division Multiple Access) link such as a cellular phone channel, a GPS (Global Positioning System) link, CDPD (cellular digital packet data), a RIM (Research in Motion, Limited) duplex paging type device, a Bluetooth, BlueTeeth or WhiteTooth radio link, or an IEEE 802.11 (Wi-Fi)-based radio frequency link. Network 102 may yet further be, include or interface to any other wired or wireless, digital or analog interface or connection.

Connection provider 110 may be or include a provider that connects the requesters to the network 102. For example, connection provider 110 may be or include an Internet service provider (ISP), a virtual private network (VPN), an intranet, a dial-up access device such as a modem, or other manner of connecting to network 102.

FIG. 1 illustrates four clients 105 connected to network 102 through two connection providers 110, but it will be understood that in practice less or significantly more users may be connected or connectable to payment system 100 than shown in FIG. 1, including through one or more connection providers 110.

The payment system 100 may include a processor 112, which may also have a connection to the network 102. Processor 112 may communicate with one or more data storage modules 114, discussed in more detail below.

Each of clients 105 used by payment initiators to manipulate payments and accounts may contain a processor module 104, a display module 108, and a user interface module 106. Each of clients 105 may have at least one user interface module 106 for interacting and controlling the computer. The user interface module 106 may be, include or interface to one or more of a keyboard, joystick, touchpad, mouse, scanner or similar device or combination of devices. In an embodiment, the display module 108 may be or include a graphical user interface (GUI) to input data and conduct other transaction tasks.

The processor 112 may maintain a connection to the network 102 through transmitter module 118 and receiver module 120. Transmitter module 118 and receiver module 120 may be or include conventional devices which enable processor 112 to interact with network 102. According to an embodiment of the invention, transmitter module 118 and receiver module 120 may be integral with processor 112. The connection to network 102 by processor 112 and clients 105 may be a broadband connection, such as through a T1 or T3 line, a cable connection, a telephone line connection, DSL connection, or other type connection.

Processor 112 functions to communicate with clients 105 and permit clients 105s to interact with each other in connection with transaction services, messaging services and other services which may be provided through payment system 100.

The processor 112 may communicate with a number of data storage modules 114. Each of data storage module 114s may stores various information associated with the payment platform, including administrator data, received instructions, transaction logs or other files or other information. According to an embodiment of the invention, each of data storage module 114s may be located on one or more data storage devices, where the data storage devices are combined or separate from processor 112. Each of data storage modules 114 may be, include or interface to, for example, the Oracle™ relational database sold commercially by Oracle Corp. Other databases, such as Informix™, DB2 (Database 2), Sybase™ or other data storage or query formats, platforms or resources such as OLAP (On Line Analytical Processing), SQL (Standard Query Language), a storage area network (SAN), Microsoft Access™ or others may also be used, incorporated or accessed in the invention. Each of data storage modules 114 may be supported by server or other resources, and may in embodiments include redundancy, such as a redundant array of independent disks (RAID), for data protection.

While a supporting architecture has been described, it will be understood that other architectures could support the operation of payment system 100. In general, the payment system 100 is designed to allow financial and other payment initiators to be able to pay bills and transfer funds when and where they want, in a selectable, integrated and optimized manner.

The payment system 100 of the invention in one regard permits a financial institution or other payment enabler to consolidate and aggregate the movement of money via the Internet, at in-person branch visits, at retail or other kiosks, over the telephone or other network and provide one view to the payment initiator. In an embodiment, a view may also be provided to a call center representative. According to an embodiment of the invention, the payment initiator may be provided with a cumulative total of bills paid and transfers made both in and out for a term defined by the payment initiator (e.g. daily, weekly, monthly, quarterly, annually). Optimizations may be executed on scheduled transactions to minimize cost or maximize float, or manage other variables.

For example, parameters can be established to allow the payment initiator to automatically pay a bill and/or transfer funds without further any involvement based on desired payment date, payment recipient such as a merchant, bank or other account holder, the dollar amount of the transaction, the source of the transaction funds, and other variables. By way of example, a payment initiator may designate that the electricity bill should be paid on the due date for a given month, to avoid a significant late fee by the utility or other entity or a surcharge applied by commercial wire delivery services. Same-day payment may be programmed for other accounts with timing sensitivity, for instance mortgage payments. The payments scheduled according to various tiers of timing may, in embodiments of the invention, be offered to the consumer or other payment initiator at different levels of costs, depending on urgency.

The payment system 100 may also allow the payment initiator to select a prospective time frame in which the payment shall be made. The time frame may be, for example, besides the same day, the next day, next week, specified date, an offset from a bill date (e.g. 2 days before due), or other designated payment windows. The payment system 100 may have an open architecture that supports various interfaces between a server or Web site and host systems such as ACH/NACHA, Wire, RPS, OFX or other protocols.

The ACH network, or automated clearing house, as administered by the NACHA, may for example provide a payment initiator with the ability to transfer funds over the ACH network. Wire transfers, which transfer funds immediately, but at a significantly greater cost than the ACH network, may also be designated by a payment initiator. A remittance process system (RPS) protocol, designed by MasterCard®, or an open financial exchange (OFX) protocol, designed by Intuit, CheckFree, and Microsoft, may also be used to transfer financial information. Other protocols may be employed.

According to an embodiment of the invention, an optimization function may be used by payment system 100 to optimize the transfer mechanisms for transferring funds. By way of example, Thursday, a payment initiator may instruct that her funds be transferred for bill payment by Friday. The payment system 100 may permit that type of short turnaround transaction to take place for instance by, in embodiments, allowing the consumer or other payment initiator to make use of payment mechanisms not generally available to consumers and others for rapid transfers, such as wire transfers or ACH transactions. The payment enabler may assign different service charges to different urgencies of payment.

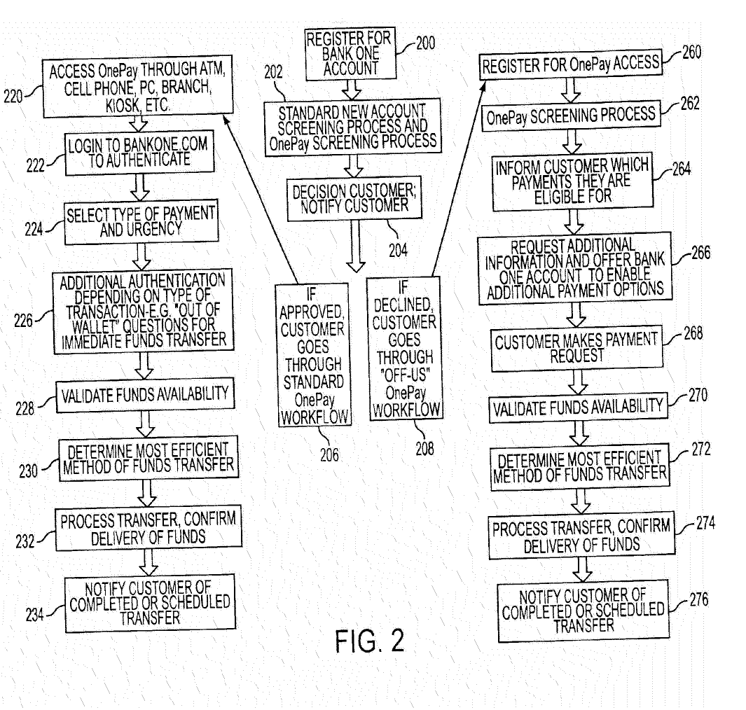

The payment system 100 may determine what method of transfer will achieve the results requested by the payment initiator, at the lowest cost to the payment enabler or while satisfying other criteria for optimal results. Other methods of optimization may also be used, for instance by utilizing rules based intelligence. Variables included in the optimization model may include, for example, classification of the funding mechanism, payee, dollar amount (for example micro payments, macro payments and others) and other rules such as time of day; lead time, dollar amount, contractual minimums, reliability, pricing, detecting and taking advantage of intra-entity transfers and others. A flowchart of transaction processing according to an embodiment of the invention is illustrated in FIG. 2. In step 200, processing of new customers (not preexisting) begins, at which point the customer, such as a consumer, a qualified business or other payment initiator may register for a new account enabled for payment system 100. Registration may be by in-person registration at a branch or other facility, Web site, telephone, any of the other network techniques illustrated in FIG. 1, or otherwise. In step 202, the customer may undergo a standard screening process, with possible further screening for the integrated payment services of the invention. The customer may sign up for one or more services, such as credit card, DDA, mutual fund, home equity, or others.

After identification, addressing and other information is gathered, at step 204 the host bank or other entity may decide which transfer mechanisms to allow to the customer depending on the customer's request, the risk the entity perceives and what the entity assesses the customer actually needs. If approval is received at step 206, the customer may be directed to an existing customer flow, such as that described below. If approval is declined at step 208, then the customer may be provided with a reduced or modified set of automated features at step 260.

In step 220, an existing customer of a financial institution or other host entity who desires access to payment system 100 may likewise be set up to enjoy an integrated method of accessing payment vehicles instead of having to deal with a differing pipelines of instruments. Using a client 105, the customer may authorize themselves at step 222 to a Web page, VRU, bank teller, CSR or other channel. The customer may then select the type of payment and the urgency, date, cost, rewards allocations or other factors at step 224. For example, a customer may want to pay a corporate credit card bill from a travel bank account. The payment initiator may direct and authorize the payment and choose to have the bill paid the day before the date it is due.

The payment initiator may permit the payment system 100 to optimize the routing and timing of that payment. If the payment initiator chooses to key the payment to a date function to avoid late fees, the payment system 100 may select the best method that will assure that funds are presented on time at the least cost, while also deferring the payment until, for example, 3 days before hand to increase the float or interest on money in a source checking account.

On the other hand, if a payment initiator prefers to program the payment system to pay bills on the day they are received to ensure they are satisfied with time to spare, the payment system 100 may generate instructions for prompt payment at the lowest transaction fee available, benefiting the payment enabler, payment initiator or both.

As a further example, if a payment initiator has procrastinated and is near to a payment due date, they may authorize an immediate and higher cost payment to ensure payment is received by any due date, such as a mortgage or credit card due date. Depending on the my selection of payment type and urgency, in step 226 the payment system 100 may determines whether additional authorization is needed to complete the scheduled transaction. Factors taken into account for approval may include the length of time that a payment initiator has been with the bank or other host entity, the number of accounts or assets maintained by the payment initiator, risk factors such as credit history or NSF history, or others.

At this point, the bank or other host entity as payment enabler may also determine whether the transaction is possible. For instance, a payment initiator may desire to send a payment for a child's college tuition. The payment initiator may want to draw $3000 from a checking account, $4000 from a home equity account, and sell $3000 from a stock brokerage account to satisfy a $10,000 school payment due. However, if the payment initiator eagerly pursues bonus point or other benefits, they may want to use a participating credit card so the points can be used to fly the college student home over a holiday.

At 226, the payment system 100 may permit the payment initiator to register these variables in a stored profile or otherwise to optimize the tuition payment according to date, amount, float, bonus points or other rewards or parameters. The bank or other host entity may determine if the payment initiator has sufficient available funds at step 228, and may suggest different solutions to the payments based on the payment initiator's profile. Once approved, the payment system 100 may determine the most efficient manner for payment in step 230. In step 232, the request for transaction approval may be transparently processed by the payment system 100. While the processing may be transparent to the payment initiator, the payment system 100 may provide a GUI tracking display 136 for customer service representative (CSR) of the bank or other host entity. If there is a question on how the item was processed, the CSR can pull up the transaction and see details in an integrated view. At step 234, the payment system 100 may notify the payment initiator of a completed or scheduled transfer via a Web page message, e-mail notification, on a statement mailed to the payment initiator or other channel.

In the case of a payment initiator seeking a payment transaction who may not be a preexisting customer of the bank or other host entity, in step 260 a person having a separately branded credit card account may wish to pay a bill on that account using a check drawn on a third party bank. The payment initiator may register for access to the payment system 100 with those or other accounts. In step 262, the host entity may authenticate the offered accounts to verify that the accounts actually exist. If they do and the customer is eligible to be set up, the host entity may inform the payment initiator which payment options he or she is eligible for to fulfill their desired transaction.

For instance, the host entity may not allow a non-customer to execute a wire transaction because once the funds are transferred, there is no way to reverse the transaction. At step 266, the host entity may therefore request authentication information to set up the process, as well as optionally offer the customer accounts with the host entity to increase payment capabilities. If the payment initiator elects to open an account with the host entity, processing may proceed to step 206.

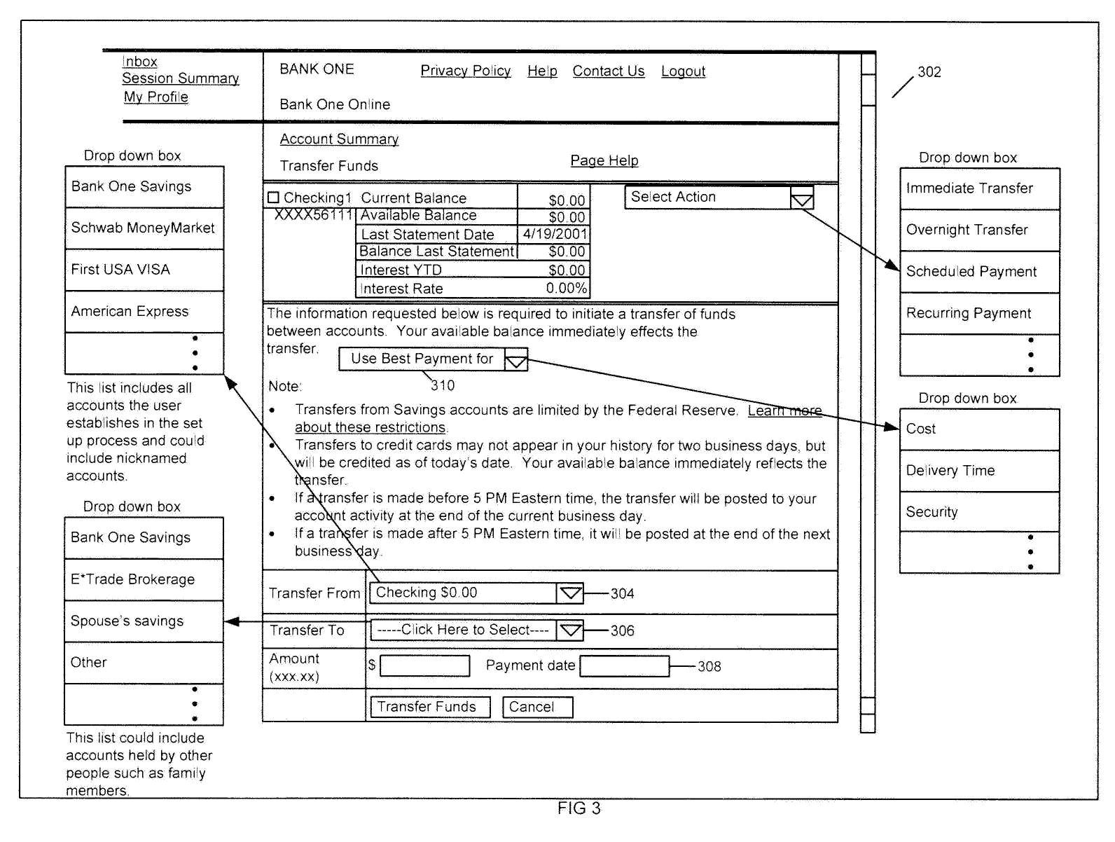

Assuming that the payment initiator wants to access the payment system 100 with their existing accounts, the available options may be made to depend on the level of risk the host entity perceives. At step 268, the payment initiator may for instance request a transfer of money from their checking account to pay their credit account. The host entity may validate the funds availability at step 270. At step 272, the payment system 100 may determine the most efficient manner to transfer the funds, but selecting among the reduced set of available payment vehicles. At step 274, the funds may be moved into an intermediary account, or pass directly through to the payee. At step 276, the payment initiator may be notified of the completed payment or scheduled payment via a Web page message, e-mail, monthly statement, page, or other channel. An illustrative interface for use by a consumer, business or other payment initiator is shown in FIG. 3, in which a GUI 302 is displayed. GUI 302 may include pay-from selector box 304 to identify accounts from which to pay bills, a payee selector box 306 to identity the recipient of the payment, a schedule selector box 308 to enter or select desired dates, date ranges or date offsets by which to effectuate payments, and an optimization selector box 310 with which to select one or more variables by which the transaction will be optimized including cost, schedule, rewards and other criteria. Other functions, such as account registration and other functions, may be provided.

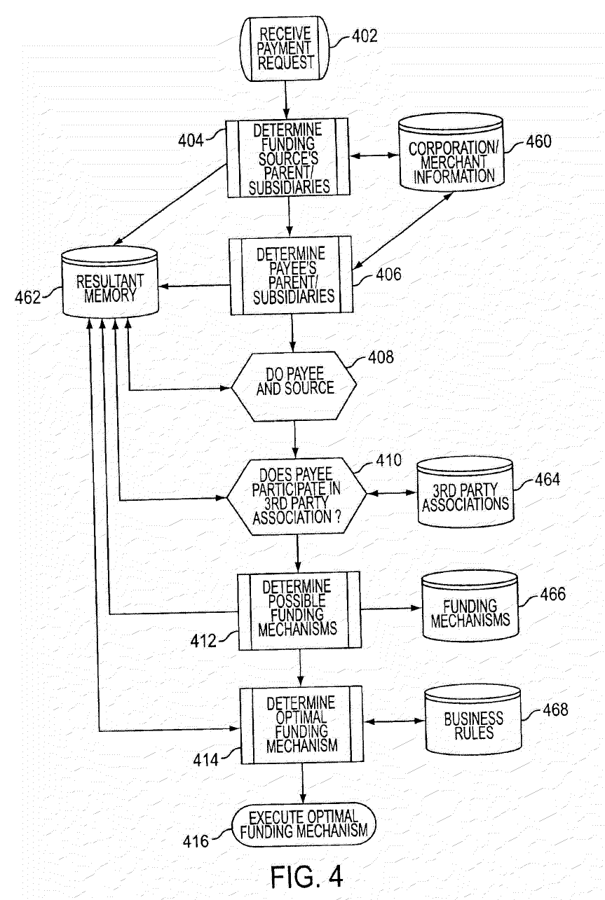

An optimization process which may be employed according to an embodiment of the invention is illustrated in FIG. 4. In step 402, a payment request is received. In step 404, a test of the funding source's affiliations may be made, for instance by running a query against a corporate database 460. The corporate database 460 may contain information describing various corporate/merchant hierarchies and interrelationships, for instance indicating that FirstUSA Bank NA is a wholly owned subsidiary of Bank One Corp. Other affiliations are possible.

In step 406, a test may be made of affiliations of the payee of the transaction, for instance by consulting corporate database 460 or other resources. In either of step 404 and 406, information regarding the detected affiliations may be stored to memory 462, such as a relational database, data cache or other resource. In step 408, a test may be made whether the payment source and payee indicate a common affiliation, such as a parent/subsidiary or other relationship.

In step 410, a test may be made whether the payee participates in a third party association that may have an effect on the transaction. This may be done by running a query against an association database 464 or other resource, for instance storing all participants in an electronic transaction network such as Spectrum™, ACH or others. In step 412, a set of possible funding mechanisms to fulfill the transaction may be generated, for instance indicated all transfer types that will fulfill minimal scheduling requirements. This may be done by running a query on funding mechanism database 466, which may include descriptive fields such as cost, eligibility criteria, time frame, risk level, security, reliability rating and others.

In step 414 an optimal funding mechanism under all the parameters of the transaction may be generated. In so doing, a business rules database 468 may be consulted, to determine whether factors such as contractual minimums, volume discounts, micro payments or other special funds processing, tiered thresholds or other rules or intelligence may be stored. The business rules may be modified over time to reflect updated market conditions or refinements to the processing model. In step 416, the optimal transaction may be executed. In various other of the steps, data may be stored to memory 462 as appropriate.

The foregoing description of the system and method of the invention is illustrative, and variations in configuration and implementation will occur to persons skilled in the art. For instance, while the invention has generally been described in terms of a processor 116 managing the scheduling and optimization of transactions over a network 102, in embodiments the processor 116 or other intelligent device may be self-contained, for instance in a desktop machine, for instance running a so-called fat client.

In other embodiments, the input interface to the payment initiator may be by way of a telephone connection, for instance via a call center facility or a voice response unit (VRU) enabled to communicate with data storage 114 or other elements. Yet further, while the invention has generally been described in terms of scheduled transactions in which the presented bill, payment source and payee all deal in the same currency, in embodiments currency conversions may be performed at appropriate stages of the transaction. Yet further, while the invention has generally been described in terms of electronic fulfillment of scheduled bills, check or other hard copy or other types of payment may be optimized and delivered according to the invention. The scope of the invention is accordingly intended to be limited only by the following claims.

1-41. (canceled)

42. A computer-implemented payment method for facilitating electronic transfer of funds between a transferor institution and a transferee institution, the payment method comprising:
receiving at a payment processor an incoming payment request designating the transferor institution, a quantity of funds to be transferred, and the transferee institution, wherein said payment request includes an initial transfer mechanism;
implementing an optimization function at the payment processor to select an optimized transfer mechanism for transferring the quantity of funds to the transferee institution, the optimized transfer mechanism providing benefits not offered through implementation of the initial transfer mechanism;
generating a payment order causing the quantity of funds to be transferred; and
notifying the requestor of the transfer of the quantity of funds.

43. The method of claim 42, further comprising receiving the incoming payment request from a payment initiator associated with the transferor institution.

44. The method of claim 42, wherein the optimization function executed by the payment processor performs optimization based on cost variables.

45. The method of claim 42, wherein the optimization function executed by the payment processor optimizes the transfer mechanism based on rewards.

46. The method of claim 42, wherein the optimization function executed by the payment processor optimizes the transfer mechanism based upon scheduling.

47. The method of claim 42, wherein the optimization function executed by the payment processor optimizes the transfer mechanism by examining relationships.

48. The method of claim 47, wherein the examined relationships include the relationships of the transferee and the transferor institution.

49. The method of claim 48, wherein the examined relationships include common affiliations between the transferee and the transferor institution.

50. The method of claim 42, further comprising searching a resource to determine if the transferee participates in a third party association that impacts the transaction.

51. The method of claim 42, further comprising generating a list of possible transfer mechanisms prior to optimization.

52. The method of claim 51, further comprising selecting the optimal transfer mechanism for the list of possible transfer mechanisms.

53. A payment system for facilitating electronic transfer of funds from a transferor institution to a transferee institution, the payment system comprising:
a data storage area for storing payment platform data;
a payment processor coupled to the data storage area;
means coupled to the payment processor for facilitating communication over a network with at least one transferor institution and at least one transferee institution, the payment processor performing the steps of
receiving a payment request. the payment request specifying a transfer amount. the transferor institution, the transferee institution, and a transfer mechanism;
evaluating available transfer mechanisms based on identities of the transferor institution and the transferee institution in order to select an optimal transfer method;
facilitating transfer of the transfer amount by the selected optimal transfer method; and
responding to the payment request with notification of the facilitated transfer.

54. The system of claim 53, wherein the payment processor further performs the step of receiving the incoming payment request from a payment initiator associated with the transferor institution.

55. The system of claim 51 wherein an optimization function executed by the payment processor performs optimization based on cost variables.

56. The system of claim 53, wherein an optimization function executed by the payment processor optimizes the transfer mechanism based on rewards.

57. The system of claim 53, wherein an optimization function executed by the payment processor optimizes the transfer mechanism based upon scheduling.

58. The system of claim 53, wherein an optimization function executed by the payment processor optimizes the transfer mechanism by examining relationships.

59. The system of claim 58, wherein the examined relationships include the relationships of the transferee and the transferor institution.

60. The system of claim 59, wherein the examined relationships include common affiliations between the transferee and the transferor institution.

61. The system of claim 53, further wherein the payment processor further searches a resource to determine if the transferee participates in a third party association that impacts the transaction.

62. The system of claim 53, wherein the payment processor further generates a list of possible transfer mechanisms prior to optimization.

63. The system of claim 62, wherein the payment processor further selects the optimal transfer mechanism for the list of possible transfer mechanisms.

64. A computer-implemented payment method for facilitating electronic transfer of funds between a transferor institution and a transferee institution, the payment method comprising:
receiving at a payment processor from a payment initiator associated with a transferor institution, an incoming payment request designating the transferor institution, a quantity of funds to be transferred, and the transferee institution, wherein said payment request includes an initial transfer mechanism;
generating a list of possible transfer mechanisms;
implementing an optimization function at the payment processor to select an optimized transfer mechanism for transferring the quantity of funds to the transferee institution, the optimized transfer mechanism providing benefits not offered through implementation of the initial transfer mechanism, the optimization function performing optimization by.
examining relationships of the transferee institution and the transferor institution including common affiliations, and
optimizing cost variables, rewards, and scheduling according to an optimization algorithm;
selecting the optimal transfer mechanism for the list of possible transfer mechanisms based on implementation of the optimization function;
generating a payment order causing the quantity of funds to be transferred; and
notifying the requestor of the transfer of the quantity of funds.
